(19) United States
(12) Patent Application Publication
(10) Pub. No.: US 2024/0418887 A1
(43) Pub. Date: Dec. 19, 2024

(54) INTEGRATION OF TIME-ATTRIBUTED GEOLOGICAL CONTEXT INTO SUBSURFACE MODELS AND SEISMIC INTERPRETATIONS

(71) Applicant: Landmark Graphics Corporation, Houston, TX (US)

(72) Inventors: Jean-Christophe Wrobel-Daveau, Abingdon (GB); Andrew Davies, Abingdon (GB)

(21) Appl. No.: 18/335,524

(22) Filed: Jun. 15, 2023

(51) Int. Cl. G01V 1/28

(52) U.S. Cl. CPC G01V 1/282; G01V 2210/1423; G01V 2210/66

(57) ABSTRACT

A method comprises obtaining geology data of a subsurface formation and generating a subsurface model of the subsurface formation, the subsurface model including one or more age-attributed geometries of a first age scheme. The method comprises obtaining a first contextual information dataset of a target age scheme and converting each of the one or more age-attributed geometries to a target age-attributed geometry based on the target age scheme. The method comprises integrating the first contextual information dataset into the subsurface model, via the one or more target age-attributed geometries, to generate a context volume. The method comprises performing a subsurface operation based on the context volume.

### TECHNICAL FIELD

This disclosure relates generally to the field of geological modeling of the subsurface and more particularly to the field of integrating contextual information into subsurface models and seismic interpretations for hydrocarbon recovery, geological storage, or mineral extraction operations.

### BACKGROUND

Seismic data may be utilized to model subsurface formations for hydrocarbon recovery. Seismic data may be interpreted to identify geological features in the subsurface formation such as faults, tops, geological bodies, etc. In some instances, attributes of the geological features, such as lithologies, porosity, depositional environment, etc. may not be apparent when interpreting seismic data. These attributes may be available in contextual information that is external to the seismic data. Integrating the contextual information into the seismic interpretations may provide an accurate model of the subsurface formations that may be further utilized in the hydrocarbon recovery and/or storage operations. The ability to automate the process of providing context to certain geobodies in seismic data and allow it to be performed globally and throughout a basin's sedimentary pile in a consistent manner may be beneficial to reservoir de-risking and decision making in hydrocarbon recovery, geological storage, and/or mineral extraction operations.

### BRIEF DESCRIPTION OF THE DRAWINGS

Embodiments of the disclosure may be better understood by referencing the accompanying drawings.

FIG. 1 is a conceptual diagram depicting an example seismic data system for obtaining seismic data of a subsurface formation, according to some implementations.

FIG. 2 is a flowchart depicting example operations for integrating geological context into a subsurface model, according to some implementations.

FIG. 3 is an illustration of a seismic profile, according to some implementations.

FIG. 4 is an illustration of a schematic workflow for integrating contextual information into a subsurface model, according to some implementations.

FIG. 5 is an illustration depicting sampling of contextual information, according to some implementations.

FIG. 6 is an illustration depicting the filling of a subsurface model with contextual information, according to some implementations.

FIG. 7 is a block diagram depicting an example computer, according to some embodiments.

### DESCRIPTION

The description that follows includes example systems, methods, techniques, and program flows that embody aspects of the disclosure. However, it is understood that this disclosure may be practiced without these specific details. For instance, this disclosure refers to integrating a contextual information dataset into a seismic interpretation. Aspects of this disclosure can also be applied to integrating more than one contextual information dataset subsurface models derived from other geology data. For clarity, some well-known instruction instances, protocols, structures, and operations have been omitted.

In-context interpretation is key for avoiding the pitfalls of misidentification of geological features in seismic data. In some implementations, the contextual information of certain geological features in seismic data may affect subsurface models for exploration and production operations of hydrocarbons and/or storage capabilities of subsurface formations. For example, carbonate build-ups can often be mistaken for volcanic features of basement. However, carbonate build-ups can only grow in certain climatic conditions (information that may not be extractable from seismic data alone). Some implementations may contextualize seismic interpretations by integrating independently derived, spatially enabled, and time-attributed geological data, interpretations, models, etc. (i.e., contextual information datasets). Example implementations may integrate seismic data (or other geology data such as surface geology data, well data, etc. or a combination of the like) with contextual information datasets such as depositional environments, paleo-climate, physio-chemical properties of rocks, etc. which may generally be modeled for a given set of geological time and a regional spatial extent, often in map domain. The integration of the two data sources may enable seismic data to be contextualized. This integration may provide a means to support a better understanding of subsurface properties for reservoir modeling, seismic inversion, machine learning predictions, etc. and eventually make more informed subsurface operation decisions.

Subsurface models may utilize specific stratigraphic subdivisions (i.e., age schemes), such as local chronostratigraphy, lithostratigraphy, etc., which may make it difficult to compare projects in a standardized manner. These age schemes may often reflect a coarse stratigraphic subdivision which may force the subsurface model's resolution to be compromised at an early stage and often focus on one single rock property (such as lithology) while many more properties (such as age, total organic content (TOC), porosity, depositional environment, paleo-climatic conditions, chemistry, physical properties, etc.) may be integrated.

Example implementations relate to converting the age scheme of age-attributed geometries within a subsurface model to integrate contextual information into the subsurface model. The age-attributed geometries of a subsurface model may be generated manually and/or automatically through interpretation of the seismic data. For example, methods, such as a densified seismic interpretation based on age mode (dense horizon method), may generate the subsurface model with age-attributed geometries. In some implementations, the subsurface model geometries (such as geometrical objects including points, lines, surfaces, etc. that may represent the position of geological objects such as stratigraphic horizons) may be utilized as an age attributed input, where the age attributes may be defined by a geological age of an age scheme. Some implementations may obtain a contextual information dataset that includes independently derived, spatially enabled, and/or time-attributed geological data, interpretations, models, etc. The age attributes of the contextual information dataset may be defined by a target age scheme that differs from the age scheme of the age-attributed geometries. Some implementations may convert the age-attributed geometries to target age-attributed geometries based on the target age scheme of the contextual information dataset. In some implementations, when there may be more than one target age-attributed geometry, incremental target age-attributed geometries (such as dense horizon intervals) may be interpolated between target age-attributed geometries in the subsurface using a geometrical projection method (such as parallel projection) and the age intervals present in the target age scheme as interpolation distance increments.

In some implementations, the subsurface model may be contextualized by joining the target age-attributed geometries of the subsurface model with one or more layers of the contextual information dataset by utilizing the respective spatial relationship and/or geological age. The contextualization of the subsurface model may generate a context volume. In some implementations, the contextual information dataset may be in the map domain. For example, the target age-attributed geometries may be converted or projected to a map domain such that it may be joined with the contextual information dataset. The context volume may include additional, and possibly higher, resolution geological time attributed contextual data (such as lithological rock facies, depositional environment, paleo-climate output, organic matter content, other chemical or physical properties, etc.) of related age (relevant either to a given horizon age or relevant to span an interval) such that more informed subsurface operation decisions may be made based on the context volume.

In some implementations, the context volume may be used to perform a subsurface operation in one or more subsurface formation. For example, a subsurface operation may be initiated, modified, or stopped based on the sediment package classifications. Examples of such subsurface operations may include completion of the wellbore, updating drilling operations, perforating, fracking, logging operations, additional sampling of the subsurface formation, wellbore placement in the subsurface formation, etc. For instance, the context volume may indicate geological features of a hydrocarbon reservoir. Accordingly, the position of a wellbore may be adjusted to maximize recovery of these hydrocarbons.

### Example System

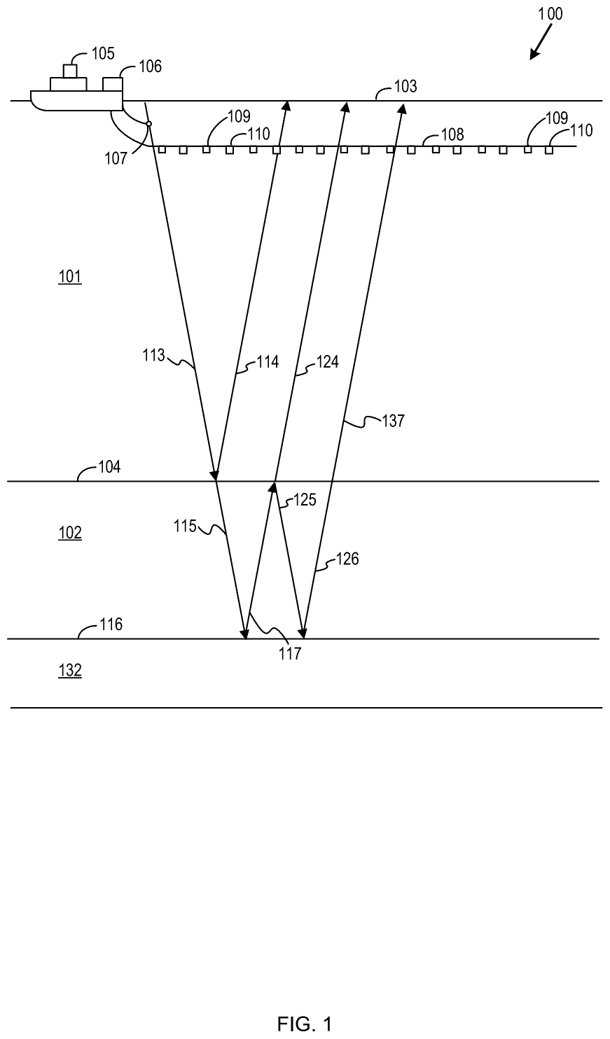

FIG. 1 is a conceptual diagram depicting an example seismic data system for obtaining seismic data of a subsurface formation, according to some implementations. FIG. 1 includes a seismic data system 100 in an offshore environment. In some implementations, a system configured to collect and process seismic data similar to seismic data system 100 may be located onshore. A body of water 101 over a first geological layer 102 is bounded at a water surface 103 by a water-air interface and at a water bottom 104 by a water-earth interface. Beneath the water bottom 104 is a subsurface formation that may include one or more formation layers such as first geological layer 102 and second geological layer 132. A seismic vessel 105 is located on the water surface 103 and includes a signal processor 106. The signal processor 106 may include a seismic data processor, navigation control, seismic source control, seismic sensor control, and recording equipment. The signal processor 106 may be local or remote to the seismic vessel 105.

The signal processor 106 may activate a seismic source 107 to actuate at selected times. In response, the seismic source 107 emits seismic waves. Seismic streamers 108 contain seismic sensors to detect the reflected waves initiated by the seismic source 107 and reflected from interfaces in the environment. The seismic streamers 108 may contain seismic sensors such as hydrophones 109 and/or water particle motion sensors such as geophones 110. The hydrophones 109 and geophones 110 are typically co-located in pairs or pairs of sensor arrays at regular intervals along the seismic streamers 108.

The seismic source 107 may be activated at periodic intervals to emit seismic waves in the vicinity of the seismic streamers 108 with the hydrophones 109 and the geophones 110. Each time the seismic source 107 is activated, an acoustic/seismic wave may travel upwardly or downwardly in spherically expanding wave fronts. In this example system, the traveling waves are depicted as ray paths normal to the expanding wave fronts. The downwardly traveling wave from the seismic source 107 traveling along a ray path 113 may reflect off the earth-water interface at the water bottom 104 and then travel upwardly along ray path 114, where the wave may be detected by the hydrophones 109 and geophones 110. Such a reflection at the water bottom 104, as in ray path 114, may contain information about the water bottom 104 and hence may be retained for further processing. Additionally, the downwardly traveling wave traveling along ray path 113 may transmit through the water bottom 104 and travel along ray path 115 before reflecting off a layer boundary 116 (i.e., horizon). This wave may then travel upwardly along ray path 117, transmit through the water bottom 104, and travel upwardly along ray path 124 until it is detected by the hydrophones 109 and geophones 110. The reflection detected by the hydrophones 109 and geophones 110 may be represented as one or more seismic traces. Seismic traces may contain useful information about the first geological layer 102. The traces of the waves traveling along ray path 114 and ray path 124 may be traces of primary reflection waves.

In addition, a portion of the wave traveling upwardly along ray path 117 may be reflected by the water bottom 104 and travel downwardly along the ray path 125. The wave traveling downwardly along ray path 125 may then be reflected by the layer boundary 116 again, travel upwardly along the ray path 126 until it transmits through the water bottom 104, and travel upwardly along the ray path 137 until it is detected by the hydrophones 109 and geophones 110. The reflection detected by the hydrophones 109 and geophones 110 may also be represented as one or more seismic traces. The seismic traces of the waves traveling along ray path 137 may be traces of seismic multiples, which have reflected off of the layer boundary 116 and the water bottom 104.

The seismic data detected by the hydrophones 109 and geophones 110 may be transmitted to the signal processor 106. The seismic data processor of the signal processor 106 may interpret seismic data to generate a subsurface model with one or more geometries. Additionally, the age attributes of the geometries may be defined by a geological age of an age scheme and the signal processor 106 may perform operations, such as converting the age attributes of the geometries to a target age attribute, integrating contextual information into the subsurface model, and performing a subsurface operation.

### Example Operations

Examples operations are now described.

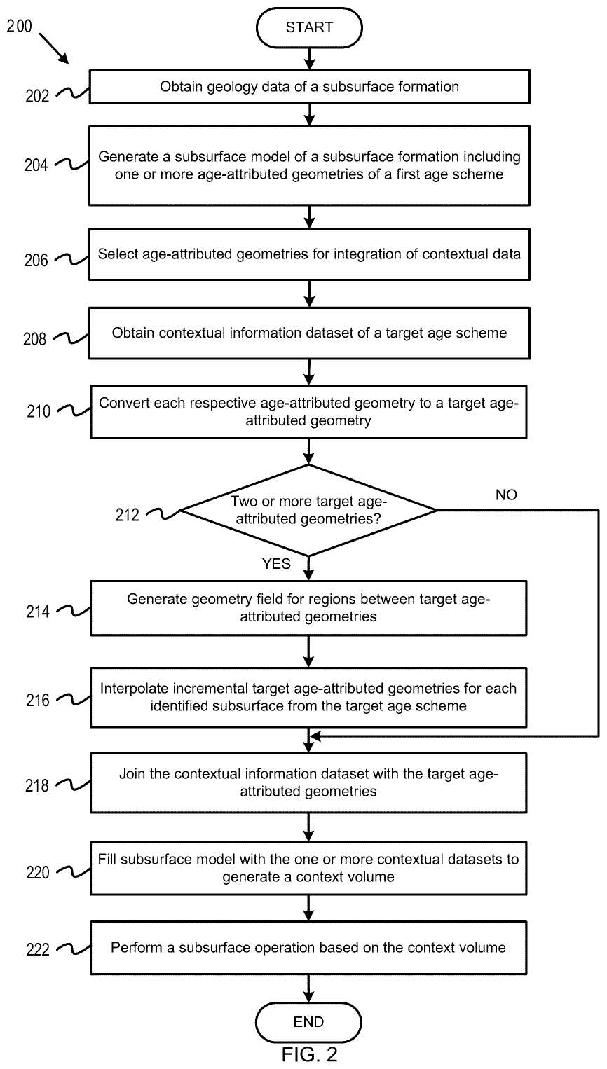

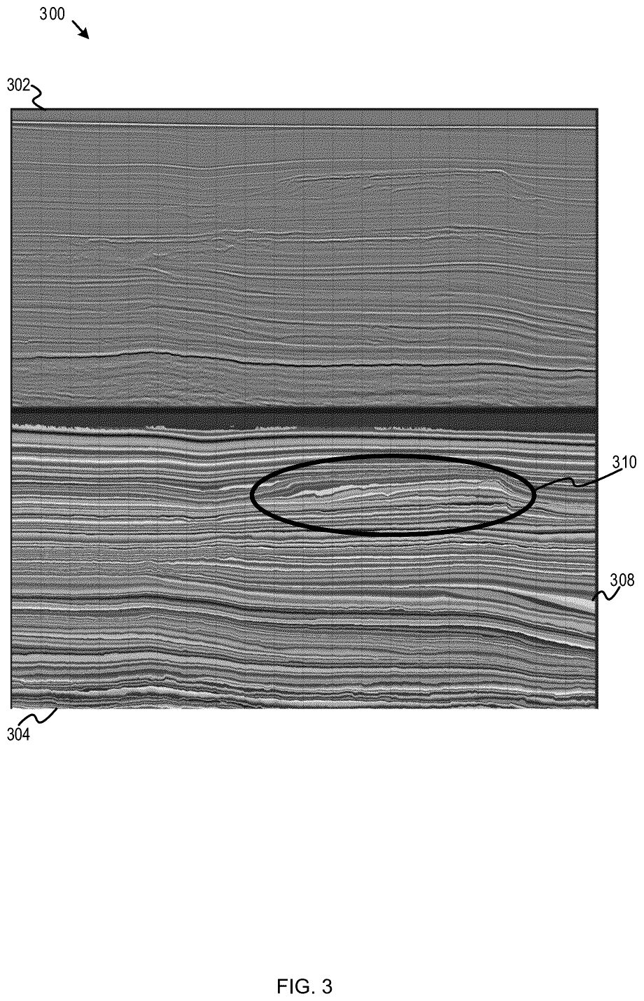

FIG. 2 is a flowchart depicting example operations for integrating geological context into a subsurface model, according to some implementations. FIG. 2 includes a flowchart 200 for converting age-attributed geometries of an age scheme to target age-attribute geometries of a target age scheme, and joining contextual data with the target age-attributed geometries to contextualize the subsurface models and/or the seismic data. The operations of the flowchart 200 are described in reference to seismic data. The operation may also include other geology data such as surface geology data, well data, etc. Operations of flowchart 200 of FIG. 2 are described in reference to the signal processor 106 of FIG. 1. Additionally, the operations of flowchart 200 are described in reference to FIGS. 3-6. Operations of the flowchart 200 start at block 202.

At block 202, the signal processor 106 may obtain geology data of a subsurface formation. The geology data may include seismic data, well data, surface geology data, etc. and/or a combination of the like. For example, the signal processor 106 may obtain seismic data from a seismic data system (such as seismic data system 100 of FIG. 1). The seismic data may be a function of depth, such as true vertical thickness (TVT), and/or two way time (TWT).

At block 204, the signal processor 106 may generate a subsurface model of a subsurface formation including one or more age-attributed geometries defined by a first age scheme. For example, the seismic data may be interpreted to generate the subsurface model. Interpretation of the seismic data may include interpreting one or more geometries of the surfaces (horizons) as part of the generation of the subsurface model. In some implementations, the subsurface model may be generated without seismic data. For instance, the subsurface model may be based on a cross-section built from surface geology data. The interpretation may include geometrical objects including points, lines, surfaces, etc. that may represent the geometries of geological features such as geological boundaries (e.g., tops, faults, stratigraphic interfaces, etc.).

To help illustrate, FIG. 3 is an illustration of a seismic profile, according to some implementations. FIG. 3 includes a seismic profile 300 of seismic data. The uninterpreted seismic profile 302 may represent raw seismic data prior to interpretation. The interpreted seismic profile 304 may represent the same seismic data as uninterpreted seismic profile 302, but with interpreted geometries (for example, interpretation by dense horizons) such as identifying geometric objects representing geological features including horizon 308, geological feature 310, etc.

Returning to block 204, in some implementations, subsurface geometries (i.e., geometrical objects) may also be obtained from automatic interpretation methods using a relative geological age model. For example, subsurface geometries may be obtained with a dense horizon interpretation.

The geological age attributes of the geometrical object interpreted in the subsurface model may be manually defined. For example, a user may define the respective age attributes from a first age scheme. The age may come from a stratigraphic term of the user's choice where distinct surfaces may be defined at given ages. In some implementations, the geological age attributes of the geometries may be defined as numerical values. The geological age attributes may be expressed in millions of years, thousands of years, etc. In some implementations, the geological age attributes may be manually assigned to each of the geometries and/or may be defined from local chronostratigraphic terms (e.g., top Cretaceous, top Jurassic, etc.), lithostratigraphic terms (e.g., formation names, groups, etc.), etc. The terms may vary across regions, companies, specialties, etc. making it difficult to compare analysis beyond. In some implementations, well data of the subsurface formations with proxies for the age (e.g., biostratigraphic markers, etc.) may be available. A user may assign an age to the surfaces in the well data. In some implementations, the ages of the respective surfaces may be defined by a scheme, which may then be converted into a numerical age via a conversion dictionary. For example, the conversion dictionary may convert the ages in a local scheme to numerical ages.

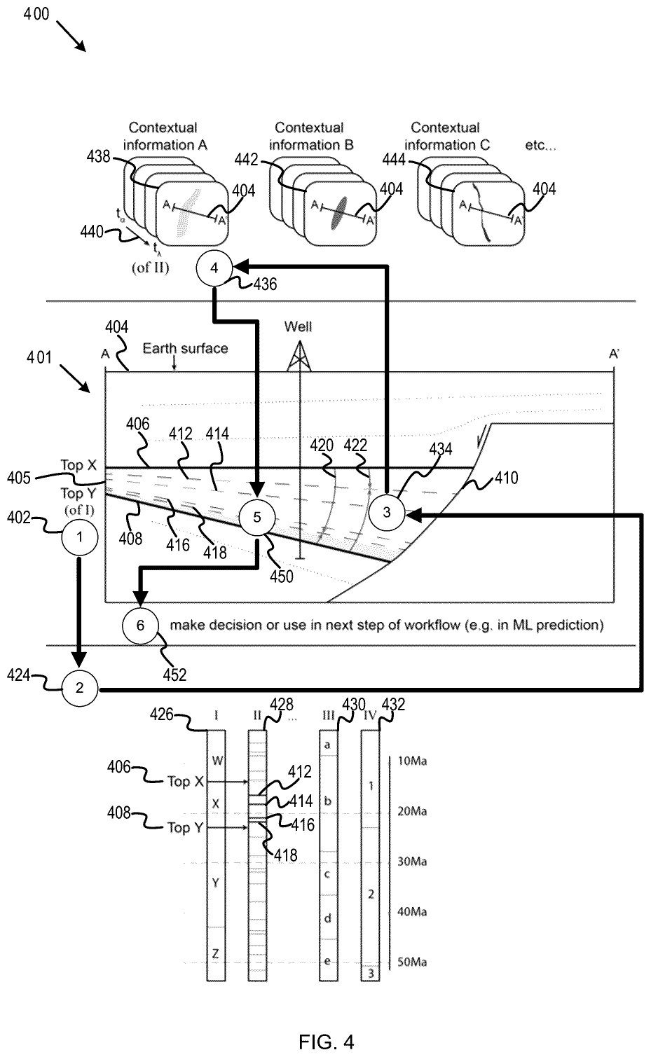

To help illustrate, FIG. 4 is an illustration of a schematic workflow for integrating contextual information into a subsurface model, according to some implementations. The workflow 400 begins at step 1 402. A subsurface model 401 is an example schematic representation of an extensional fault block along cross section 404, where formation X 405 was deposited between time Y (i.e., older), and time X (i.e., younger), as defined by absolute geological ages in age scheme I 426. The formation X 405 may be interpreted to be the region between tops X 406 and top Y 408, and terminates at fault 410 in the subsurface model. The top X 406, top Y 408, and/or fault 410 may be identified as geometries (i.e., geometrical objects) within the seismic data when generating the subsurface model 401, each of the geometries may be defined with respective age attributes from age scheme I 426.

Such ages may be converted into other age terms (i.e., schemes) for the purpose of eventually linking to age-attributed geological contextual information, as described below.

In some implementations, the subsurface model generated by dense horizon may also include known age constraints. The subsurface model with the known age constraints generated in dense horizon may represent a local geological age scheme that may be converted to a target age scheme (described in block 216). Additionally, the dense geometries may be utilized as an input to generate denser interpolated geometries to reflect the time increments from the target age scheme.

At block 206, the signal processor 106 may select one or more age-attributed geometries to process for the integration of the contextual information dataset. For example, top X 406 and top Y 408 of FIG. 4 may be selected. One or more subsurface geometries may be selected for the integration of the contextual data. For example, the number of subsurface geometries selected may depend on the time resolution of the contextual information dataset or the intent of the user.

At block 208, the signal processor 106 may obtain a contextual information dataset of a target age scheme. For example, with reference to FIG. 4, contextual information dataset 438 may be obtained. The contextual information dataset may be obtained for reasons such as the intent of the user, the resolution of the contextual information dataset, the resolution of the age-attributed geometries, etc. In some implementations, only a portion of the contextual information dataset may be obtained. For example, a portion of layers (described below) from a contextual information dataset may be obtained.

In some implementations, the contextual information dataset may be externally sourced geological data, information, models etc. For example, contextual information datasets 438, 442, and 444 may be external data sources. Each of the contextual information datasets 438, 442, and 444 may include different types of contextual information including lithology, TOC, paleo-climate conditions, depositional environment, physio-chemical properties, etc. In some implementations, a contextual information dataset may include multiple sources of information and/or include contextual information similar to a different contextual information dataset. The contextual information datasets may include layers. For example, the contextual information dataset may be in a map domain, where the dataset comprises layers of maps. Each of the maps (layers) may represent different ages. For example, contextual information dataset 438 may include layers from ages t_{α} to t_{λ}, where t_{α} is the oldest and t_{λ} is the youngest. The age attributes of the contextual information datasets may be defined by an age scheme. For example, the age attributes of the contextual information dataset 438 may be defined by age scheme II 428, age scheme III 430, or age scheme IV 432 of FIG. 4.

The selection of the of a given contextual information dataset may condition the target age scheme automatically. For example, when contextual information dataset 438 is selected, the respective age scheme (age scheme II 428) may automatically become the target age scheme. The respective age scheme may also be manually selected as the target age scheme when the contextual information dataset is obtained.

At block 210, the signal processor 106 may convert each respective age-attributed geometry to a target age-attributed geometry. The age attribute assigned to each geometry may be converted to an age attribute of the target age scheme. The age attributes may be converted by using the numerical age equivalent of the geometries in both the original age scheme and the target age scheme using the most appropriate, recent, and/or updated scheme (and potentially associated uncertainty on the age). In some implementations, methods that include ordering relations between geometries in a preferred hierarchy may be utilized to convert each age attribute of the geometries.

The target age scheme may be manually selected and/or defined automatically based on the requirement from the contextual information dataset to integrate to the subsurface model. For example, if contextual information dataset 438 is selected for integration and uses age scheme II 428, then age scheme II 428 automatically becomes the target age scheme. Additionally, at step 2 424, the age attributes (defined by age scheme I 426) of top X 406 and top Y 408 of FIG. 4 may be converted to the target age scheme (age scheme II 428).

This may allow identifying the age of recognized geometries within a different scheme that may be the closest in age of the geometry selected (in the case that there may only be one geometry selected for integration) or encompassed between pairs of subsurface geometries (in the case that there may be two or more geometries selected for integration). In implementations when two or more geometries may be selected, within the time intervals defined between pairs of geometries, the target age scheme may include several additional age intervals that may be identified (i.e., incremental target age-attributed geometries 412, 414, 416, and 418). The incremental geometries may need to be interpolated geometrically onto the subsurface model based on their respective relative age interpolation used a created geometry field between the original geometries.

At block 212, the signal processor 106 may determine if there are two or more target age-attributed geometries. If there are two or more target age-attributed geometries, the operations continue to block 214. Otherwise, operations proceed to block 218.

At block 214, the signal processor 106 may generate a geometry field for regions between target age-attributed geometries. The geometry field may use defining lines to define its geometry. Additionally, the geometry field may include one or more boundary lines (such as a fault, unconformity, etc.) to limit the extent of the calculation. For example, top X 406 and top Y 408 in the target age scheme may be utilized as the defining lines for the geometry field, and fault 410 may be utilized as the boundary line for the geometry field. The generation of the geometry field may return the proportional distance between two geometries (such as top X 406 and top Y 408) along the projection guidelines.

Projection methods such as parallel projection, similar projection, proportional stratigraphic layering, etc. may be utilized to generate the geometry field. Parallel projection may project a horizon parallel to itself along guideline projection lines which may be perpendicular to the original surface. Similar projection may project a distance along a vertical guiding line or guiding lines oblique to the surface. Proportional stratigraphic layering may be utilized for complex geometrical relationships (i.e., geometric shapes are not parallel) between two geometries, such as non-parallel curved layers (with non-constant curvatures). For example, projection lines 420, 422 may be generated via a proportional projection method and may define the relationship between the defining lines (top X 406 and top Y 408).

At block 216, the signal processor 106 may interpolate incremental target age-attributed geometries for each identified subsurface from the target age scheme. In some implementations, different geometries may be recognizable through different age schemes. For example, incremental target age-attributed geometries 412, 414, 416, and 418 may be recognizable in age scheme II 428, but not in age scheme I 426. The geometry field may be populated with incremental target age-attributed geometries using a distance increment proportional to the time increment between the two original defining geometries (defining lines). For instance, at step 3 434, the region between the target age-attributed geometries that are the defining lines (top X 406 and top Y 408) may be populated with incremental target age-attributed geometries 412, 414, 416, and 418 via projection lines 420, 422. The incremental target age-attributed geometries and defining lines may be connected through the absolute (i.e., numerical) age of the respective geometries.

In some implementations, the geometrical interpretation may also integrate more complex geological rules (such as physical rules of sediment deposition providing a geometrical output) to fill the stratigraphic basin space for a given interval.

In some implementations, if the contextual information dataset obtained in block 208 does not have a higher resolution than the subsurface model, then incremental target age-attributed geometries may not be generated. For example, the age scheme of the contextual information dataset does not present any other surfaces within the defining lines of the geometry field.

At block 218, the signal processor 106 may join the contextual information dataset with the target age-attributed geometries. The target age-attributed geometries and/or the incremental target age-attributed geometries generated for each increment of geology time in the target age scheme may be linked to the contextual information dataset. For example, the target age-attributed geometries (top X 406 and top Y 408) and/or the incremental target age-attributed geometries (incremental target age-attributed geometries 412, 414, 416, and 418) may be joined at step 4 436 of FIG. 4. In some implementations, the contextual information dataset may be generated and stored in the form of maps to reflect the contextual information visualized as projected on the Earth's surface.

Each of the target age-attributed geometries may be projected to the Earth's surface to generate a geospatial object such as a point, a line, a polygon, etc. in a map domain. In some implementations, the target age-attributed geometries may be projected to the map domain using vertical projection. Each time-attributed geometry projected from the subsurface of the Earth may be joined with one or more layers of the contextual information at the Earth's surface at a spatial intersection on the Earth's surface for a time of interest. In some implementations, one or more layers of the contextual information dataset may by joined with one or more target-age-attributed geometries.

In some implementations, for a given surface age, contextual information may be sampled at the location of the intersection of a given geometric object with the surface map. Alternatively, the contextual information can be sampled at a distance from the projected subsurface profile/surface. As such, using a sampling distance may allow uncertainty/likelihood of a given type of contextual information and inform the user on possible alternative context as provided by the external data source. This method may return a likely probability of occurrence of a given geological context along a line representing the projected geometries of a given age. It may allow alternative interpretations to be proposed as well as extend the area for identification of contextual data type transition (e.g., facies transition).

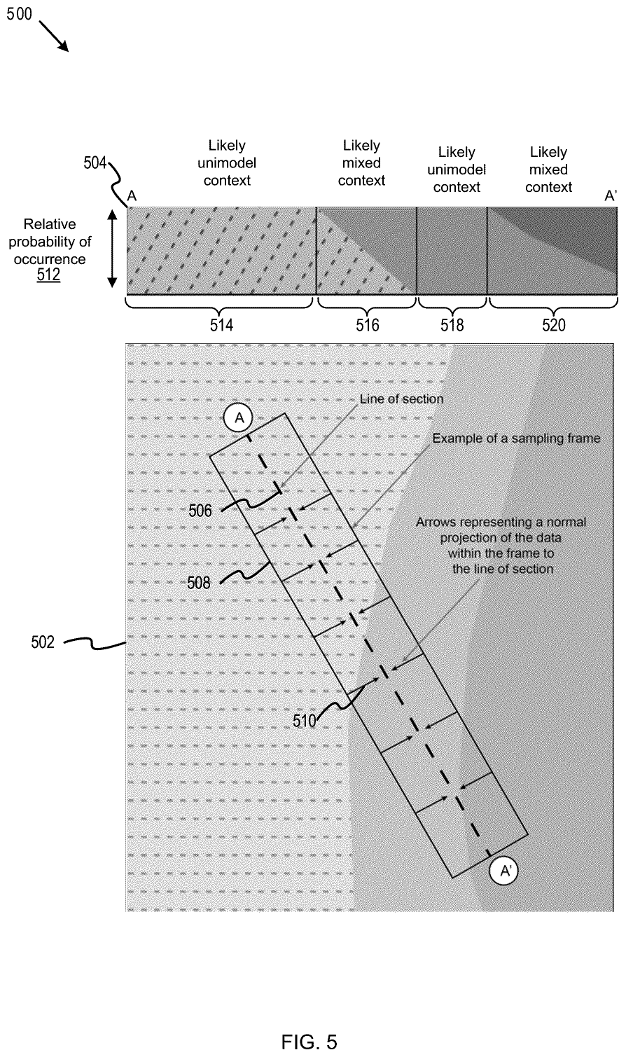

To help illustrate, FIG. 5 is an illustration depicting sampling of contextual information, according to some implementations. The contextual data 500 includes a map 502 representing a contextual information dataset. The line of section 506 from A to A′ may be the location of the seismic profile. The sampling frame 508 around the line of section 506 may represent the sampling distance of contextual information to be integrated to the subsurface model for a given geological age or a stack of geological ages. The arrows, such as arrow 510 on the map 502 may represent a normal projection of the contextual data to the profile. In some implementations, the projection may also be defined at a certain angle based on structural trends and/or input from geostatistics. The contextual information dataset in map 502 for a given geological age may be sampled using a sampling frame 508, such as a rectangle frame, covering a given distance from the line of section 506. Contextual information within the sampling frame 508 may be projected to the line of section 506 using a normal projection orientation depicted by arrows such as arrow 510. The chart 504 may represent the likely relative proportion of the sampled contextual data as projected along the line of section 506 for that given surface. The chart 504 has a y-axis 512 that represents the relative probability of occurrence of the sampled contextual data in the seismic profile. In the example illustration of sampled contextual data, section 514 is a likely unimodel context, section 516 is a likely mixed context, section 516 is a likely unimodel context, and section 518 is a likely mixed context.

The contextual information dataset may then be transferred to the incremental target age-attributed subsurface geometries and be represented/visualized in the subsurface model.

At block 220, the signal processor 106 may fill the subsurface model with the one or more contextual datasets to generate a context volume. For example, one or more layers of the contextual information dataset 438 may be integrated into the subsurface model 401 at step 450. The contextual information dataset joined with each respective target-age attributes geometry may include attributes associated with the respective geometry. Attributes may include lithology, facies, climate context, etc. Thus, by filling the subsurface model with the contextual information dataset at the respective geometries, the subsurface model may be filled with attributes at the respective locations to contextualize the interpreted seismic data. The contextual information dataset may apply to the target age-attributed subsurface geometries in the subsurface model. In some implementations, the contextual information dataset may apply to geometrical regions located between pairs of geometries (such as surfaces). For example, contextual data including stratigraphic information (e.g., carbonate, sandstone) may apply to a region defined by two target age-attributed subsurface geometries.

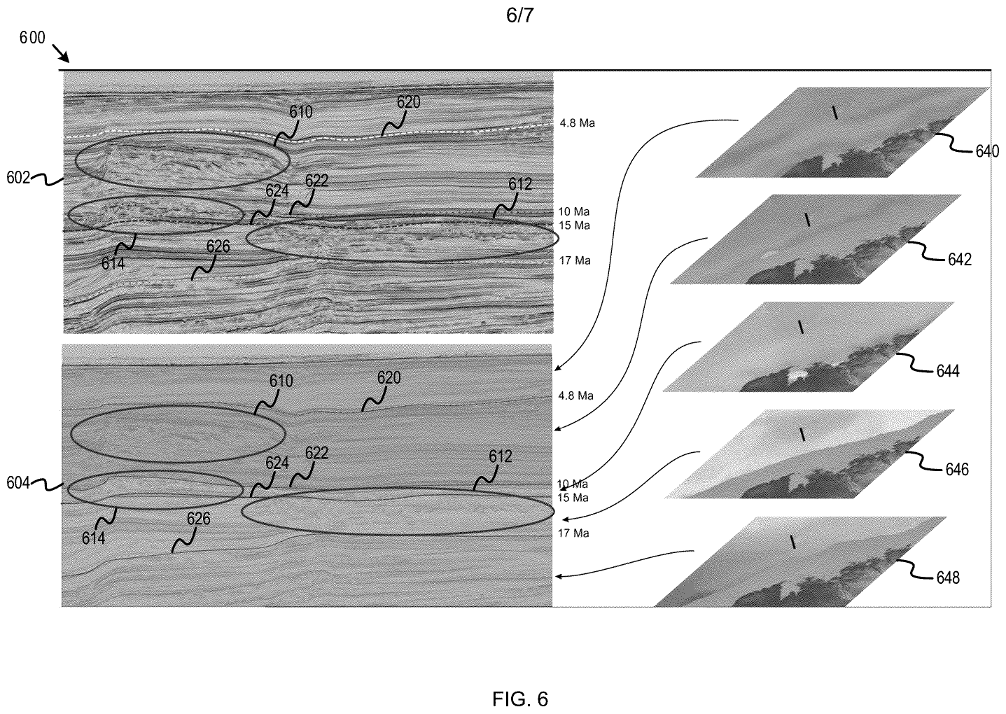

To help illustrate, FIG. 6 is an illustration depicting the filling of a subsurface model with contextual information, according to some implementations. FIG. 6 includes a seismic dataset 600 with an interpreted seismic reflection profile 602 and a contextualized interpreted seismic reflection profile 604. Features 610, 612, and 614 are interpreted geometries that indicate the possible location of tropical carbonate buildups. Surfaces 620, 622, 624, 626 are age-attributed seismic surfaces. Contextual information dataset includes maps 640, 642, 644, 646, and 648 (such as contextual information dataset 438 of FIG. 4). The maps 640-648 may represent chance maps of occurrences of tropical carbonate (map 640 having the greatest chance and map 648 having the lowest chance) as predicted from paleo-climate modeling for different ages. In some implementations, the features 610, 612, and 614 may be converted to a target age scheme (the age scheme of maps 640-648) and spatio-temporally joined with the maps 640-648. Accordingly, the maps 640-648 may be integrated into the subsurface model to provide insight into attributes (such as temperature, salinity, etc.) of the features 610, 612, and/or 614 that may indicate if carbonate build ups are present in the subsurface formations. Individual parameters and/or a combination of parameters may be utilized to measure a carbonate likelihood. One or more individual attributes may be utilized to provide a measure of carbonate likelihood. In some implementations, the information, such as the attributes, in addition to the seismic data, may then be utilized in a machine learning model to determine whether the features may be carbonate build ups.

At block 222, the signal processor 106 may perform a subsurface operation based on the context volume. For example, at step 6 452, a decision regarding a subsurface operation may be made based on the context volume or the context volume may be utilized in another workflow (such as a machine learning prediction algorithm). Implementations described herein may automize part of the process related to the integration of contextual data such as geoscientific knowledge contained in external data sources into subsurface models. This may save interpretation time, improve consistency, and allow for faster exploration and production decision making. Once contextual information is integrated into the subsurface models, it may allow more informed strategic decisions. For example, the positioning of an extraction and/or an injection well may be determined based on the context volume. Alternatively, the decision may be to acquire additional data types such as new seismic data or drill an exploration well.

Integration of contextual information may support seismic processing and/or reprocessing, inversion, seismic time/depth migration, etc. as at least part of the contextual information dataset, such as knowledge of the lithologic properties of rock, may improve the results obtained in processing and/or reprocessing, inversion, and seismic time/depth migration. In some implementations, the integration of contextual information dataset may also represent a useful pre-requisite to the development of further machine learning algorithms involving seismic data.

### Example Computer

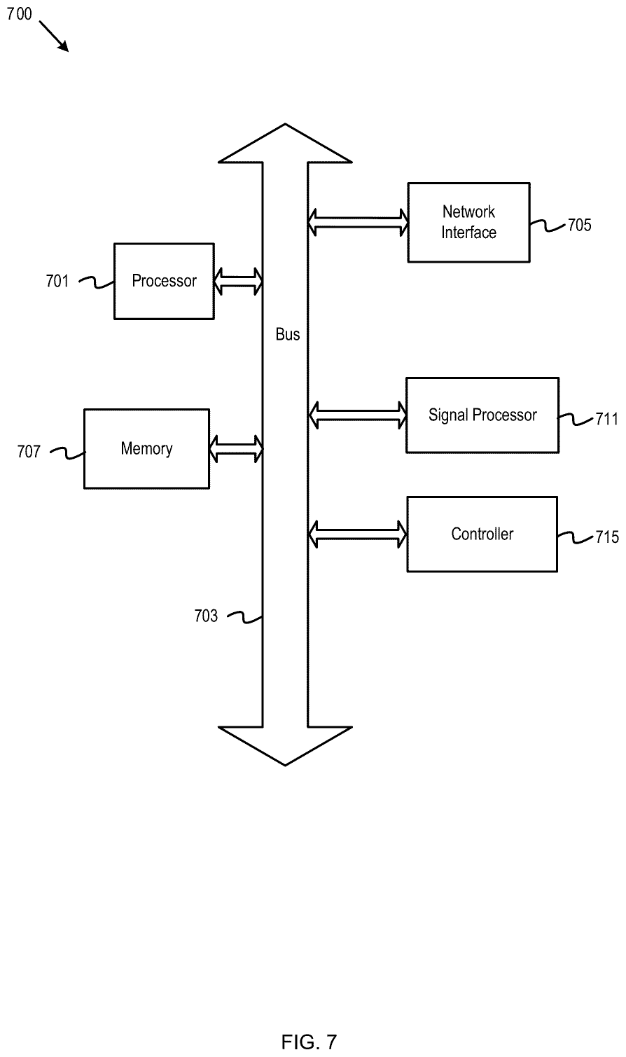

FIG. 7 is a block diagram depicting an example computer, according to some embodiments. FIG. 7 depicts a computer 700 for integrating contextual information with seismic data. The computer 700 includes a processor 701 (possibly including multiple processors, multiple cores, multiple nodes, and/or implementing multi-threading, etc.). The computer 700 includes memory 707. The memory 707 may be system memory or any one or more of the above already described possible realizations of machine-readable media. The computer 700 also includes a bus 703 and a network interface 705. The computer 700 can communicate via transmissions to and/or from remote devices via the network interface 705 in accordance with a network protocol corresponding to the type of network interface, whether wired or wireless and depending upon the carrying medium. In addition, a communication or transmission can involve other layers of a communication protocol and or communication protocol suites (e.g., transmission control protocol, Internet Protocol, user datagram protocol, virtual private network protocols, etc.).

The computer 700 also includes a signal processor 711 and a controller 715 which may perform the operations described herein. For example, the signal processor 711 may process geology data and convert age attributes of a geometry in a subsurface model from an age scheme to a target age scheme. The signal processor 711 may also integrate one or more contextual information datasets with the target age-attributed geometries to fill the subsurface model with the contextual information to generate a context volume. The controller 715 may perform a subsurface operation based on the context volume. The signal processor 711 and the controller 715 can be in communication. Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, realizations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, it will be understood that these aspects are illustrative and that the scope of the claims is not limited to them. In general, techniques for seismic horizon mapping as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

### EXAMPLE EMBODIMENTS

Implementation #1: A method comprising: obtaining geology data of a subsurface formation; generating a subsurface model of the subsurface formation, the subsurface model including one or more age-attributed geometries of a first age scheme; obtaining a first contextual information dataset of a target age scheme; converting each of the one or more age-attributed geometries to a target age-attributed geometry based on the target age scheme; integrating the first contextual information dataset into the subsurface model, via the one or more target age-attributed geometries, to generate a context volume; and performing a subsurface operation based on the context volume.

Implementation #2: The method of implementation #1, further comprising: generating, via a projection method, a geometry field in the subsurface model for a first region between a first target age-attributed geometry and a second target age-attributed geometry; generating one or more incremental target age-attributed geometries based on the first region; and integrating the first contextual information dataset into the subsurface model via the one or more incremental target age-attributed geometries.

Implementation #3: The method of implementation #2, wherein the projection method includes a proportional stratigraphic laying method, a parallel projection method, and a similar projection method.

Implementation #4: The method of any one or more of implementations #1-3, further comprising: projecting the one or more target age-attributed geometries to a map domain; joining the one or more target age-attributed geometries with one or more layers of the first contextual information dataset based on a geological age and a spatial intersection; obtaining one or more attributes corresponding to the target age-attributed geometry based on the one or more layers; and integrating the one or more attributes into the subsurface model.

Implementation #5: The method of implementation #4, wherein the one or more layers of the first contextual information dataset is in the map domain.

Implementation #6: The method of implementation #4, wherein the one or more attributes include lithology, facies, and climate context.

Implementation #7: The method of any one or more of implementations #1-6, wherein the first contextual information dataset may span between multiple target age-attributed geometries.

Implementation #8: The method of any one or more of implementations #1-7, wherein the one or more age-attributed geometries represent geological features in the subsurface formation and include a point, a line, and a surface, and wherein the geological features include a top, a fault, and a stratigraphic interface.

Implementation #9: The method of any one or more of implementations #1-8, wherein the first contextual information dataset includes information including lithological rock facies, depositional environment, paleo-climate output, and organic matter content.

Implementation #10: A non-transitory, computer-readable medium having instructions stored thereon that are executable by a processor to perform operations comprising: obtaining geology data of a subsurface formation; generating a subsurface model of the subsurface formation, the subsurface model including one or more age-attributed geometries of a first age scheme; obtaining a first contextual information dataset of a target age scheme; converting each of the one or more age-attributed geometries to a target age-attributed geometry based on the target age scheme; integrating the first contextual information dataset into the subsurface model, via the one or more target age-attributed geometries, to generate a context volume; and performing a subsurface operation based on the context volume.

Implementation #11: The non-transitory, computer-readable medium of implementation #10, further comprising: generating, via a projection method, a geometry field in the subsurface model for a first region between a first target age-attributed geometry and a second target age-attributed geometry; generating one or more incremental target age-attributed geometries based on the first region; and integrating the first contextual information dataset into the subsurface model via the one or more incremental target age-attributed geometries.

Implementation #12: The non-transitory, computer-readable medium of implementation #11, wherein the projection method includes a proportional stratigraphic laying method, a parallel projection method, and a similar projection method.

Implementation #13: The non-transitory, computer-readable medium of any one or more of implementations #10-12, further comprising; projecting the one or more target age-attributed geometries to a map domain; joining the one or more target age-attributed geometries with one or more layers of the first contextual information dataset based on a geological age and a spatial intersection; obtaining one or more attributes corresponding to the target age-attributed geometry based on the one or more layers; and integrating the one or more attributes into the subsurface model.

Implementation #14: The non-transitory, computer-readable medium of implementation #13, wherein the one or more layers of the first contextual information dataset is in the map domain.

Implementation #15: The non-transitory, computer-readable medium of any one or more of implementations #10-14, wherein the geology data includes seismic data, well data, and surface geology data.

Implementation #16: The non-transitory, computer-readable medium of any one or more of implementations #10-15, wherein the one or more age-attributed geometries represent geological features in the subsurface formation and include a point, a line, and a surface, and wherein the geological features include a top, a fault, and a stratigraphic interface.

Implementation #17: The non-transitory, computer-readable medium of any one or more of implementations #10-16, wherein the first contextual information dataset includes information including lithological rock facies, depositional environment, paleo-climate output, and organic matter content.

Implementation #18: A system comprising: a processor; and a computer-readable medium having instructions stored thereon that are executable by the processor to cause the processor to, obtain geology data of a subsurface formation; generate a subsurface model of the subsurface formation, the subsurface model including one or more age-attributed geometries of a first age scheme; obtain a first contextual information dataset of a target age scheme; convert each of the one or more age-attributed geometries to a target age-attributed geometry based on the target age scheme; integrate the first contextual information dataset into the subsurface model, via the one or more target age-attributed geometries, to generate a context volume; and perform a subsurface operation based on the context volume.

Implementation #19: The system of implementation #18, wherein the instructions comprise instructions that are executable by the processor to cause the processor to, generate, via a projection method, a geometry field in the subsurface model for a first region between a first target age-attributed geometry and a second target age-attributed geometry; generate one or more incremental target age-attributed geometries based on the first region; and integrate the first contextual information dataset into the subsurface model via the one or more incremental target age-attributed geometries.

Implementation #20: The system of implementation #18 or #19, wherein the instructions comprise instructions that are executable by the processor to cause the processor to, project the one or more target age-attributed geometries to a map domain; joining the one or more target age-attributed geometries with one or more layers of the first contextual information dataset based on a geological age and a spatial intersection; obtaining one or more attributes corresponding to the target age-attributed geometry based on the one or more layers; and integrating the one or more attributes into the subsurface model.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
obtaining geology data of a subsurface formation;
generating a subsurface model of the subsurface formation, the subsurface model including one or more age-attributed geometries of a first age scheme;
obtaining a first contextual information dataset of a target age scheme;
converting each of the one or more age-attributed geometries to a target age-attributed geometry based on the target age scheme;
integrating the first contextual information dataset into the subsurface model, via the one or more target age-attributed geometries, to generate a context volume; and
performing a subsurface operation based on the context volume.

2. The method of claim 1, further comprising:
generating, via a projection method, a geometry field in the subsurface model for a first region between a first target age-attributed geometry and a second target age-attributed geometry;
generating one or more incremental target age-attributed geometries based on the first region; and
integrating the first contextual information dataset into the subsurface model via the one or more incremental target age-attributed geometries.

3. The method of claim 2, wherein the projection method includes a proportional stratigraphic laying method, a parallel projection method, and a similar projection method.

4. The method of claim 1, further comprising:
projecting the one or more target age-attributed geometries to a map domain;
joining the one or more target age-attributed geometries with one or more layers of the first contextual information dataset based on a geological age and a spatial intersection;
obtaining one or more attributes corresponding to the target age-attributed geometry based on the one or more layers; and
integrating the one or more attributes into the subsurface model.

5. The method of claim 4, wherein the one or more layers of the first contextual information dataset is in the map domain.

6. The method of claim 4, wherein the one or more attributes include lithology, facies, and climate context.

7. The method of claim 1, wherein the first contextual information dataset may span between multiple target age-attributed geometries.

8. The method of claim 1, wherein the one or more age-attributed geometries represent geological features in the subsurface formation and include a point, a line, and a surface, and wherein the geological features include a top, a fault, and a stratigraphic interface.

9. The method of claim 1, wherein the first contextual information dataset includes information including lithological rock facies, depositional environment, paleo-climate output, and organic matter content.

10. A non-transitory, computer-readable medium having instructions stored thereon that are executable by a processor to perform operations comprising:
obtaining geology data of a subsurface formation;
generating a subsurface model of the subsurface formation, the subsurface model including one or more age-attributed geometries of a first age scheme;
obtaining a first contextual information dataset of a target age scheme;
converting each of the one or more age-attributed geometries to a target age-attributed geometry based on the target age scheme;
integrating the first contextual information dataset into the subsurface model, via the one or more target age-attributed geometries, to generate a context volume; and
performing a subsurface operation based on the context volume.

11. The non-transitory, computer-readable medium of claim 10, further comprising:
generating, via a projection method, a geometry field in the subsurface model for a first region between a first target age-attributed geometry and a second target age-attributed geometry;
generating one or more incremental target age-attributed geometries based on the first region; and
integrating the first contextual information dataset into the subsurface model via the one or more incremental target age-attributed geometries.

12. The non-transitory, computer-readable medium of claim 11, wherein the projection method includes a proportional stratigraphic laying method, a parallel projection method, and a similar projection method.

13. The non-transitory, computer-readable medium of claim 10, further comprising;
projecting the one or more target age-attributed geometries to a map domain;
joining the one or more target age-attributed geometries with one or more layers of the first contextual information dataset based on a geological age and a spatial intersection;
obtaining one or more attributes corresponding to the target age-attributed geometry based on the one or more layers; and
integrating the one or more attributes into the subsurface model.

14. The non-transitory, computer-readable medium of claim 13, wherein the one or more layers of the first contextual information dataset is in the map domain.

15. The non-transitory, computer-readable medium of claim 10, wherein the geology data includes seismic data, well data, and surface geology data.

16. The non-transitory, computer-readable medium of claim 10, wherein the one or more age-attributed geometries represent geological features in the subsurface formation and include a point, a line, and a surface, and wherein the geological features include a top, a fault, and a stratigraphic interface.

17. The non-transitory, computer-readable medium of claim 10, wherein the first contextual information dataset includes information including lithological rock facies, depositional environment, paleo-climate output, and organic matter content.

18. A system comprising:
a processor; and
a computer-readable medium having instructions stored thereon that are executable by the processor to cause the processor to,
obtain geology data of a subsurface formation;
generate a subsurface model of the subsurface formation, the subsurface model including one or more age-attributed geometries of a first age scheme;
obtain a first contextual information dataset of a target age scheme;
convert each of the one or more age-attributed geometries to a target age-attributed geometry based on the target age scheme;
integrate the first contextual information dataset into the subsurface model, via the one or more target age-attributed geometries, to generate a context volume; and
perform a subsurface operation based on the context volume.

19. The system of claim 18, wherein the instructions comprise instructions that are executable by the processor to cause the processor to,
generate, via a projection method, a geometry field in the subsurface model for a first region between a first target age-attributed geometry and a second target age-attributed geometry;
generate one or more incremental target age-attributed geometries based on the first region; and
integrate the first contextual information dataset into the subsurface model via the one or more incremental target age-attributed geometries.

20. The system of claim 18, wherein the instructions comprise instructions that are executable by the processor to cause the processor to, project the one or more target age-attributed geometries to a map domain;
joining the one or more target age-attributed geometries with one or more layers of the first contextual information dataset based on a geological age and a spatial intersection;
obtaining one or more attributes corresponding to the target age-attributed geometry based on the one or more layers; and
integrating the one or more attributes into the subsurface model.
